(19) United States
(12) Patent Application Publication
(10) Pub. No.: US 2004/0044614 A1
(43) Pub. Date: Mar. 4, 2004

(54) Live auction using electronic auction paddles

(76) Inventor: Roger Wagner, La Mesa, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/430,905

(22) Filed: May 7, 2003

Related U.S. Application Data
(60) Provisional application No. 60/378,514, filed on May 7, 2002.

(51) Int. Cl. G06F 17/60

(52) U.S. Cl. 705/37

(57) ABSTRACT

Aspects of the present invention include a system for facilitating live auctions using electronic auction paddles to chronologically register bids. In one embodiment, an electronic auction-hosting device wirelessly communicates with a plurality of electronic auction paddles to register bids from bidders having the paddles. The host device may also include a display for providing a wide variety of information to the participants in the live auction, such as, for example, the paddle registering the currently high bid, the current bid, bid histories, information about the product or item being auctioned, and the like.

### REFERENCE TO RELATED APPLICATIONS

This application claims the benefit of U.S. Provisional Application No. 60/378,514, filed May 7, 2002, and entitled “Integrated, Computer Moderated Live Auction and Electronic Auction Paddles For Use Therewith.” The present application incorporates the foregoing disclosure herein by reference.

### BACKGROUND OF THE INVENTION

1. Field of the Invention

The present disclosure relates in general to live auctions, and in particular to live auctions that accept bids from electronic devices.

2. Description of the Related Art

In general, live auctions include an auctioneer moderating the auction, real-time bidders present at the auction generally holding numbered paddles having numbers, proxy or agent bidders in communication with remote bidders, absentee bidders who send in advance bids, and the like. To auction an item, often from a consignor, the auctioneer may review any absentee bids to understand absentee bid limits. The auctioneer then announces a starting bid and looks for one or more real-time bidders or agent bidders to raise their numbered paddles. When a real-time bidder or agent bidder raises the bid, the auctioneer may raise the bid to the next increment for one or more absentee bids. Once the bidding stops, the auctioneer announces the winning bid.

The foregoing live auctions suffer from a variety of drawbacks. For example, the auctioneer often speaks and moderates at a very high rate of speed. Moreover, more than one bidder may raise their paddles during a single bid cycle. Thus, an individual bidder often can not be sure the current bid belongs to him or her, or whether that bid is in the currently high bid. Additionally, when active bidders appear in a substantially direct line of sight from the auctioneer, such as, for example, sitting in the same relative seat in spaced apart rows, the bidders may not realize who actually has the current bid. For example, a first bidder sitting closer to the auctioneer may raise his or her paddle and the auctioneer may indicate the acceptance of bid in his or her direction. However, a second bidder sitting behind the first bidder may be the actual bidder the auctioneer noted as possessing the current bid. Even more elementary, when active bidding occurs, the auctioneer may assign bids in the order he or she visually identifies them rather than in the actual chronological order of the bidders' bids.

In addition to the foregoing drawbacks, live auctions often suffer, fairly or not, from potential unfairness perceived by the participants of an auction. For example, a consignor may have set the reserve for his or her item at $1,000, while an absentee bidder may have provided a written bid of up to $5,000 for that item. Because the auctioneer usually reviews the absentee bid, the auctioneer may start the bidding at a higher value, such as, for example, $1,500, even though the only bidder may be the absentee bidder. Alternatively, auctioneers may select less motivated bidders first to artificially inflate the bidding for a single highly motivated bidder.

To avoid the drawbacks of live auctions, on-line companies such as ebay®, Inc. and priceline.com®, Inc. now offer software systems that moderate a wide variety of on-line conventional and reverse auction opportunities. However, such electronic auction software systems are not designed for or usable in a live auction environment. Moreover, such on-line auctions often require relatively complex client systems, such as, for example, personal computers, laptops, and handheld personal digital assistants to participate in the on-line auction.

Embodiments of the present disclosure seek to overcome some of all of these and other drawbacks.

### SUMMARY OF THE INVENTION

Accordingly, aspects of the present disclosure include a live auction system comprising a host device communicating with electronic auction paddles. According to one embodiment, an electronic auction-hosting device communicates with one or more electronic auction paddles that allow bidders to communicate bids to the host device. Generally, the host device can uniquely recognize each paddle and can determine when a bidder actuates the paddle to register a bid through the same. Because the host device advantageously registers the moment the bidder actuates his or her electronic auction paddle, many of the drawbacks of live auctions can be overcome. For example, one or more display devices can be used to inform auction participants of the actuation of a particular electronic paddle and/or the bid amount corresponding to the actuation.

According to one embodiment, the electronic auction paddles comprise one-way communication, for example, transmitting bidder actuations to the host device. According to another embodiment, the electronic auction paddles comprise two-communication devices, advantageously registering on the paddles at least some of the wide variety of information useful that can be useful to the bidder. For example, the electronic auction paddles may include a plurality of indicators, such as lights, which are activated by the host device to indicate to the respective bidder that his or her bid is the currently highest bid, is not the currently highest bid, or that the bidding for a particular item has started or finished.

According to yet another embodiment, the electronic auction paddles may include more sophisticated computing systems capable of displaying information about an item for auction, some or all of the items being auctioned, other advertising relevant to the auction, combinations of the same, or the like. The auction paddles may include digital readouts, LCD or other display screens, or the like, displaying information about the item, bid amounts, bidder information, consignment reserve values, valuation information by one or more product evaluators, absentee bids, or the like.

For purposes of summarizing the invention, certain aspects, advantages, and novel features are described herein. Of course, it is to be understood that not necessarily all such aspects, advantages or features will be embodied in any particular embodiment of the invention.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 illustrates a block diagram of an exemplary embodiment of an auction system.

FIGS. 2-3 illustrate block diagrams of exemplary embodiments of electronic auction paddles of the auction system of FIG. 1.

FIG. 4 illustrates another exemplary embodiment of an auction system.

### DETAILED DESCRIPTION OF THE PREFERRED EMBODIMENT

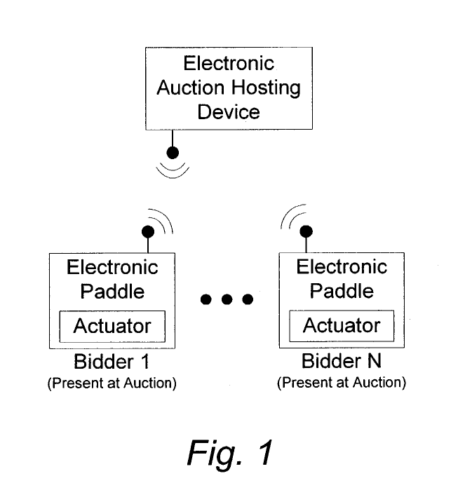

Aspects of the present invention include a live auction system using electronic auction paddles. As shown in FIG. 1, the an electronic auction-hosting device communicates with one or more electronic auction paddles. During an auction, a bidder actuates the actuator on his or her electronic paddle and the host device registers the current high bid to that bidder. According to one embodiment, the hosting device uniquely identifies each electronic auction paddle through any of a number of know identification techniques, including information exchanged in handshaking routines, particular transmission attributes such as transmission frequency, header information, encryption information, combinations of the same or the like. In an embodiment where the electronic auction paddles are hardwired to the host device, the unique identification may include the particular port over which information is delivered. In other embodiments, the host device and the electronic auction paddles may wirelessly communicate using any number of protocols implementing radio-frequency (RF) transmissions, infrared (IR) transmissions, or the like.

In an embodiment, the hosting device includes one or more displays viewable by the bidders. The display may indicate the current bid value, the holder of the highest bid by paddle number, name, other identification information, generic information such as an asterisk in the case of desired privacy, combinations of the same or the like. Thus, the host device and the electronic auction paddles advantageously provide an auction environment where the receipt of a particular bid is accepted in a nonbiased chronological manner and in the embodiment including one or more host displays, each bidder can clearly and unambiguously know whether he or she is holding the current highest bid.

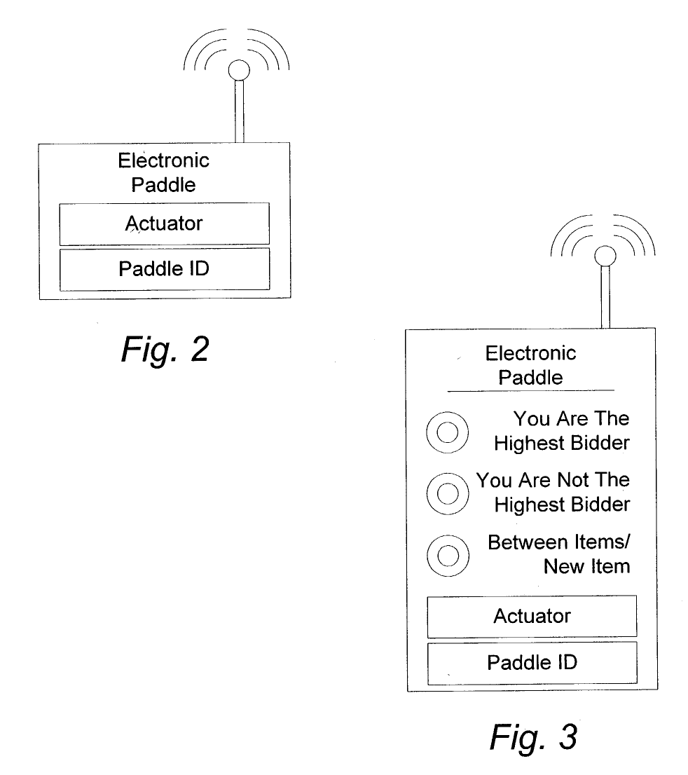

FIG. 2 illustrates the electronic auction paddle comprising an actuator, a unique paddle identifier, and a wireless communication device. According to one embodiment, the electronic auction paddle of FIG. 2 employs one-way communication transmitting information related to the actuation by the bidder of an associated electronic auction paddle. According to one embodiment, the communication may include a safety protocol to ensure transmission from a particular paddle comprises the desire of that paddle's user to register a bid. For example, the protocol may include actuation of the button for a specific length of time, a predetermined number of actuations, actuating multiple actuators on a paddle in a particular order or at the same time, combinations of the same, or the like.

FIG. 3 illustrates a more sophisticated embodiment of the electronic auction paddle. As shown in FIG. 3, the electronic auction paddle communicates with the host device to provide feedback to the relevant bidder. For example, the electronic auction paddle may include a plurality of indicators, such as LEDs or the like, which are activated by the host device to indicate to the respective bidder that his or her bid is the currently highest bid, is not the currently highest bid, or that the bidding for a particular item has started or finished.

In one embodiment, the electronic auction paddles may indicate to the corresponding bidder whether he or she won the auction and/or now owns the consigned item. For example, one or more of the foregoing plurality of indicators may activate, blink, or otherwise provide feedback to the bidder. In the embodiment shown in FIG. 3, the first and the third LEDs may activate to show the bidder that he or she has won the auction, and the second and the third LEDs may activate to show the bidder he or she did not win.

According to yet another embodiment, the electronic auction paddles may include more sophisticated computing systems capable of displaying information about an item for auction, some or all of the items being auctioned, other advertising relevant to the auction, combinations of the same, or the like. The auction paddles may include digital readouts, LCD or other display screens, or the like, displaying information about the item, bid amounts, bidder information, consignment reserve values, valuation information by one or more product evaluators, absentee bids, or the like.

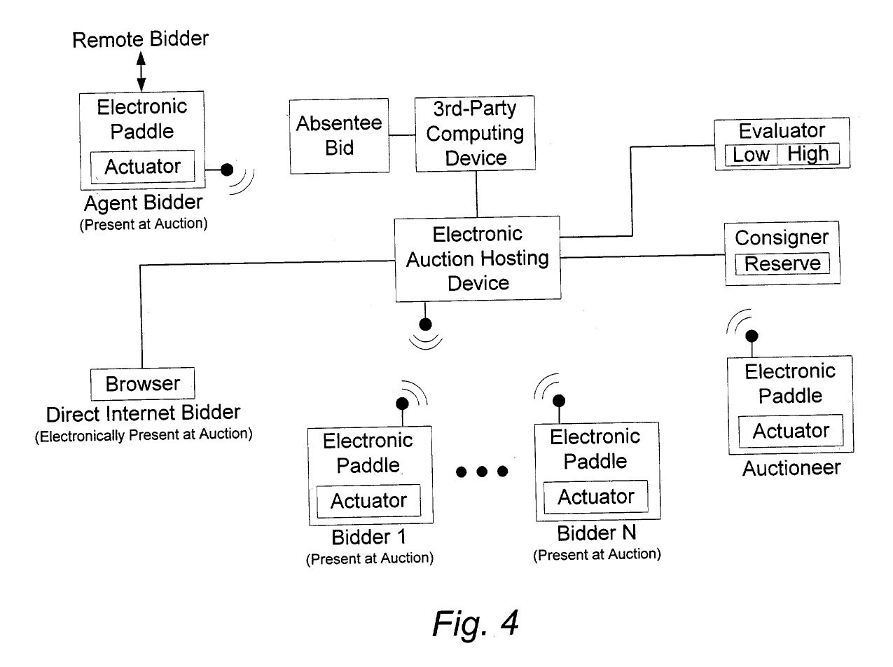

FIG. 4 illustrates a block diagram of an auction system including an electronic auction-hosting device using electronic auction paddles similar to those disclosed with reference to FIGS. 1-3. Additionally, the auction system can include internet bidders, such as, for example, bidders connected through a computer network to the host device. The connection may include a connection over a communication medium such as the Internet. In other embodiments, the communications medium can be any communication system including by way of example, dedicated communication lines, telephone networks, wireless data transmission systems, two-way cable systems, customized computer networks, interactive kiosk networks, automatic teller machine networks, interactive television networks, combinations of the same, and the like.

The auction system of FIG. 4 may also include a remote bidder, communicating in any conventional manner with an agent bidder having his or her electronic paddle. For example, the remote bidder and the agent bidder may communicate via the Internet, wireless or wired devices, cellular, satellite, or conventional telephone, combinations of the same, or the like. In one embodiment, the auction proceedings may be broadcast via a computer network such that the remote bidder may follow the action occurring during the current auction. The computer network may comprise the Internet, public or private computer networks, kiosks, communicating hand-held computing devices, combinations of the same, or the like.

FIG. 4 also shows the auction system including a third-party computing device storing one or more absentee bids. According to one embodiment, the third-party computing device may be used to enter information from absentee bidders and may be kept separated from, for example, information available to the auctioneer or the auction sponsor. Thus, the third-party computing device advantageously guards against any allegation of impropriety based on absentee bids, such as those discussed in the Background herein.

FIG. 4 also shows the auction system including the consignor entering his or her reserve amount for a particular item into the host device, and/or an evaluator entering his or her evaluation as to the value, condition, or the like of a particular item. Moreover, the host device may include an electronic auction paddle for the auctioneer, allowing the auctioneer to start, end, or interrupt the auction for a particular item. For example, when one or more of the electronic auction paddles or the auction system incurs some type of technical difficulty, the auctioneer may interrupt the current auction to ensure fair play for all bidders.

Based on the foregoing, embodiments of the auction system disclosed with reference to FIGS. 1-4 advantageously remove suspect and often-disadvantageous discretion from the live auction process. Moreover, the auction system of the present disclosure advantageously ensures appropriate chronological bid registration and may include one or more displays providing information related to the auction process, such as, for example, the bid history and result of an auction for a particular item.

In one embodiment, the auctioneer may be able to enter bids on behalf of other bidders, such as, for example, absentee bidders, bidders having technical or other difficulty with their electronic auction paddles, or the like.

Although the foregoing invention has been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. Accordingly, the present invention is not intended to be limited by the reaction of the preferred embodiments, but is to be defined by reference to the appended claims.

What is claimed is:

1. An auction system for registering bids during an auction for a particular item, the auction system comprising:
a plurality of electronic paddles usable by bidders at a live auction, each of the plurality of electronic paddles comprising an actuator usable by one of the bidders to enter a bid on an item auctioned during the live auction; and
an electronic auction-hosting device capable of receiving electronic information sufficient to register as the currently highest bid, the bid from the electronic paddle associated with the one bidder.

2. The auction system of claim 1, wherein the plurality of electronic paddles wirelessly transmit the electronic information to the electronic auction-hosting device.

3. The auction system of claim 1, wherein the electronic auction-hosting device wirelessly communicates with the plurality of electronic paddles.

4. The auction system of claim 3, wherein each of the plurality of electronic paddles include indicia for indicating whether a bidder's bid was received as the currently highest bid.

5. The auction system of claim 3, wherein each of the plurality of electronic paddles include indicia for indicating when the bidder is not registered as having the currently highest bid.

6. The auction system of claim 3, wherein each of the plurality of electronic paddles include indicia for indicating when the auction is not currently active.

7. The auction system of claim 1, further comprising at least one connected bidder computing device communicating with the electronic auction-hosting system through a computer network and capable of registering a bid.

8. The auction system of claim 1, further comprising a computing device capable of communicating information representing one or more absentee bids to the auction device for the particular item.

9. The auction system of claim 1, wherein the electronic auction-hosting device receives information from one or more evaluators determining at least one of high and low valuations for the particular item.

10. The auction system of claim 1, wherein the electronic auction-hosting device receives reserve value information from a consignor associated with the particular item.

11. The auction system of claim 1, further comprising an auctioneer electronic device capable of starting the live auction.

12. The auction system of claim 1, further comprising an auctioneer electronic device capable of ending the live auction.

13. The auction system of claim 1, further comprising an auctioneer electronic device capable of interrupting the live auction.

14. The auction system of claim 1, further comprising an auctioneer electronic device capable of entering bids for present and/or absent bidders.

15. A method of registering a bid from a bidder present during a live auction on an item being auctioned, the method comprising:
monitoring a plurality of electronic devices held by bidders physically present at a live auction;
receiving a transmission representing a bid from one of the plurality of electronic devices; and
storing information uniquely identifying the one of the plurality of electronic devices in the order that the transmission was received.

16. The method of claim 15, further comprising displaying information to the bidders representing the received bid from the one electronic device.

17. The method of claim 15, further comprising associating a current bid price with the information uniquely identifying the one electronic device.

18. The method of claim 15, further comprising receiving absentee bid information.

19. The method of claim 15, further comprising receiving valuation information.

20. The method of claim 15, further comprising receiving reserve information from a consignor.

21. The method of claim 15, further comprising directly receiving bid information over a computer network from a remote bidder monitoring the auction through the computer network.
